(19) United States
(12) Patent Application Publication
(10) Pub. No.: US 2008/0062279 A1
(43) Pub. Date: Mar. 13, 2008

(54) IMAGE PROCESSING METHODS AND SYSTEMS

(75) Inventors: Jing Shun LIN, Yilan County (TW); Chao Lien TSAI, Taipei City (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN (TW)

(21) Appl. No.: 11/849,480

(22) Filed: Sep. 4, 2007

(30) Foreign Application Priority Data
Sep. 8, 2006 (TW) TW95133196

(51) Int. Cl. H04N 5/222

(52) U.S. Cl. 348/231.3

(57) ABSTRACT

Image processing methods and systems for use in digital cameras. An image is captured. A region image of a specific region in the image is copied. Data information is embedded on the specific region of the image. The region image, a start address of the specific region in the image, and an offset region corresponding to the region image are recorded to an image file. The image with the data information and an offset corresponding to the image are recorded to the image file. The image without the data information can be recovered by composing the region image to the image.

### BACKGROUND OF THE INVENTION

1. Field of the Invention

The invention relates generally to image processing methods and systems, and, more particularly, to image processing methods and systems providing varying display of data information such as date, time, location, temperature in digital cameras.

2. Description of the Related Art

Data stamp functionality is provided in digital cameras, allowing information such as date and time display on an image during capture. When the image is viewed in the digital camera or a computer system, the information is available known.

Users may prefer flexibility in the information display. For example, no date information may be desired when images are viewed in the digital camera, but date information may be desired viewed in computer systems. Conventional date stamp function is a destructive action, being directly embedded in images for perpetuity, such that original images without data information cannot be obtained.

### BRIEF SUMMARY OF THE INVENTION

Image processing methods and systems are provided.

In an embodiment of an image processing method, an image is captured. A region image of a specific region in the image is copied. Data information is embedded on the specific region of the image. The region image, a start address of the specific region in the image, and an offset region corresponding to the region image are recorded to an image file. The image with the data information and an offset corresponding to the image are recorded to the image file.

In an embodiment of an image processing method, an image is captured. A region image of a specific region in the image is copied. Data information is embedded on the region image. The region image with the data information, a start address of the specific region in the image, and an offset region corresponding to the region image are recorded to an image file. The image and an offset corresponding to the image are recorded to the image file.

In an embodiment of an image processing method, an image file is obtained. An offset is read from the image file, and an image is read from the image file according to the offset. An offset region is read from the image file, and a region image is read from the image file according to the offset region. A start address is read from the image file, and the region image is composed to the image according to the start address.

An embodiment of an image processing system comprises an image sensor and a processing unit. The image sensor captures an image. The processing unit copies a region image of a specific region in the image, and embeds data information on the specific region of the image. The processing unit records the region image, a start address of the specific region in the image, and an offset region corresponding to the region image to an image file. The processing unit records the image with the data information and an offset corresponding to the image to the image file.

An embodiment of an image processing system comprises an image sensor and a processing unit. The image sensor captures an image. The processing unit copies a region image of a specific region in the image, and embeds data information on the region image. The processing unit records the region image with the data information, a start address of the specific region in the image, and an offset region corresponding to the region image to an image file. The processing unit records the image and an offset corresponding to the image to the image file.

An embodiment of an image processing system comprises a processing unit. The processing unit obtains an image file. The processing unit reads an offset from the image file, and reads an image from the image file according to the offset. The processing unit reads an offset region from the image file, and reads a region image from the image file according to the offset region. The processing unit reads a start address from the image file, and composes the region image to the image according to the start address.

Image processing methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image processing system;

FIG. 2 is a flowchart of an embodiment of a method of image file generation;

FIG. 3 is an example illustrating the format of an image file;

FIG. 4 is a flowchart of an embodiment of a method of image file generation;

FIG. 5 is a flowchart of an embodiment of an image processing method; and

FIG. 6 is a flowchart of an embodiment of an image processing method.

### DETAILED DESCRIPTION OF THE INVENTION

Image processing methods and systems are provided.

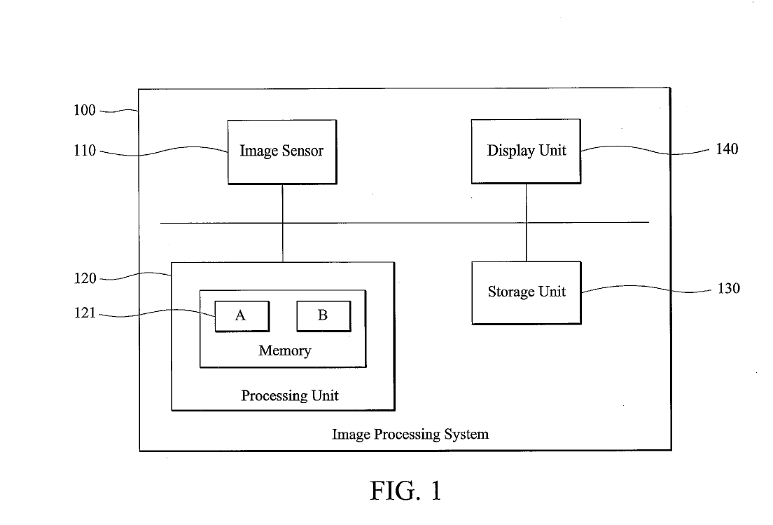

FIG. 1 illustrates an embodiment of an image processing system.

The image processing system 100 may be a digital camera, comprising an image sensor 110, a processing unit 120, a storage unit 130 and a display unit 140. The image sensor may be a CCD (Charge Coupled Device) or CMOS (Complementary Metal Oxide Semiconductor), capturing an image. The processing unit 120 controls the image sensor 110, and performs the image processing methods of the invention, such as image capture, compression, storage, and others. The storage unit 130 may be a built-in memory or external memory card of the digital camera. The display unit 140 may be a LCD (Liquid Crystal Display) monitor of the digital camera or a display device separate from the digital camera. The display unit 140 displays images or related operation interfaces required for the image processing methods of the invention.

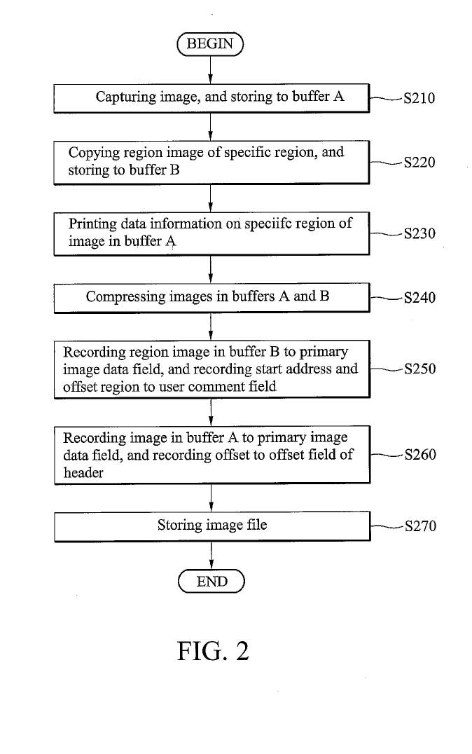

FIG. 2 shows an embodiment of a method of image file generation.

In step S210, an image is captured via the image sensor 110, and the image is stored to a buffer A. In step S220, a region image of a specific region in the image is copied, and the region image is stored to a buffer B. It is noted that the specific region may be a location such as the lower right of the image, where display is desired of information such as date and time. In step S230, data information is embedded such as printed on the specific region of the original image in buffer A. In step S240, the images in buffers A and B are compressed. It is understood that the data information may be any kind of information desired to be embedded to the image. For example, the data information comprises date, time, location, temperature, and others. It is noted that if the location information is embedded to the image, a positioning device such as GPS (Global Positioning System) is provided in the image processing system. Similarly, if the temperature information is embedded to the image, a temperature sensor is provided in the image processing system.

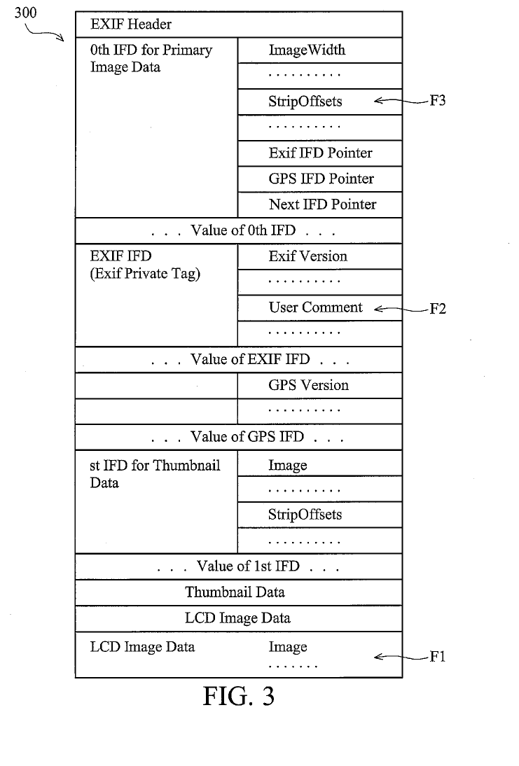

In step S250, the region image in buffer B is recorded to a primary image data field of an image file, such as F1 in FIG. 3. Further, a start address of the specific region in the original image and an offset region corresponding to the region image are recorded to a user comment field of the image file, such as F2 in FIG. 3. The offset region is a range in the primary image data field occupied by the region image. In step S260, the image in buffer A is recorded to the primary image data field of the image file. In some embodiments, the image in buffer A can be recorded following the region image in the primary image data field. Further, an offset corresponding to the image is recorded to an offset field of a header of the image file, such as F3 in FIG. 3. The offset is the storage address of the image in the primary image data field. In step S270, the image file is stored to the storage unit 130. It is understood that the image file format in FIG. 3 is an example, and not limited thereto. Any file format can be applied in the invention.

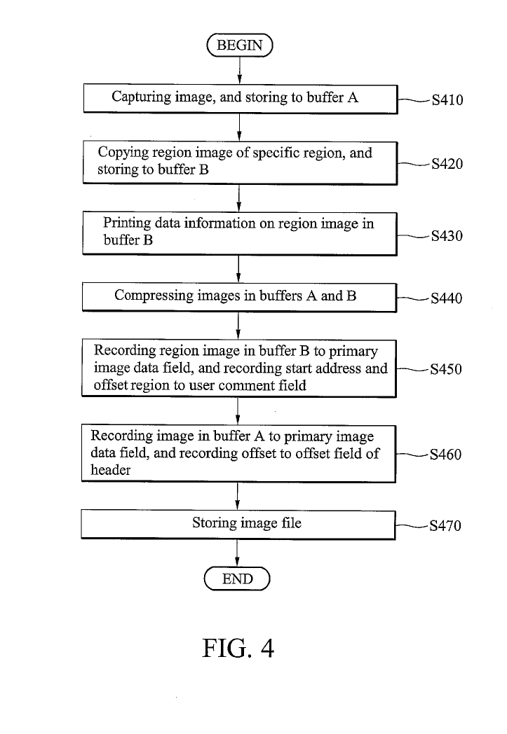

FIG. 4 shows an embodiment of a method of image file generation. In this embodiment, the data information is embedded on the region image in buffer B. Similarly, the data information comprises date, time, location, temperature, and others.

In step S410, an image is captured via the image sensor 110, and the image is stored to a buffer A. In step S420, a region image of a specific region in the image is copied, and the region image is stored to a buffer B. Similarly, the specific region may be a location such as the lower right of the image, where display is desired of information such as date and time. In step S430, data information is printed on the region image in buffer B. In step S440, the images in buffers A and B are compressed.

In step S450, the region image in buffer B is recorded to a primary image data field of an image file. Further, a start address of the specific region in the original image and an offset region corresponding to the region image are recorded to a user comment field of the image file. The offset region is a range in the primary image data field occupied by the region image. In step S460, the image in buffer A is recorded to the primary image data field of the image file. Similarly, in some embodiments, the image in buffer A can be recorded following the region image in the primary image data field. Further, an offset corresponding to the image is recorded to an offset field of a header of the image file. The offset is the storage address of the image in the primary image data field. In step S470, the image file is stored to the storage unit 130.

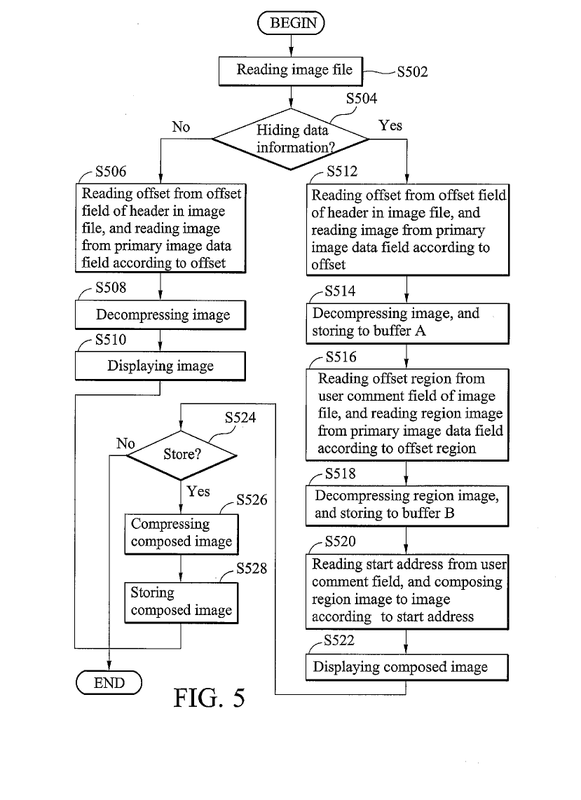

FIG. 5 shows an embodiment of an image processing method. In this embodiment, it is determined whether data information is to be hidden from the image. The image file generated according to FIG. 2 can be used in this embodiment.

In step S502, an image file is read from the storage unit 130. In step S504, it is determined whether to hide data information. It is noted that a specific field, such as user comment field of the image file generated according to the invention can be used to record a specific tag such as 1, representing a region image existed in the image file. When the specific tag is read and if the tag is 1, step S504 is performed. If not (No in step S504), in step S506, an offset is read from the offset field of the header of the image file, and an image is read from the primary image data field of the image file according to the offset. In step S508, the image is decompressed to obtain the image with data information, and in step S510, the image is displayed in the display unit 140. If so (Yes instep S504), in step S512, an offset is read from the offset field of the header of the image file, and an image is read from the primary image data field according to the offset. In step S514, the image is decompressed to obtain an image with data information, and stored to buffer A. In step S516, an offset region is read from the user comment field of the image file, and a region image is read from the primary image data according to the offset region. In step S518, the region image is decompressed, and stored to buffer B. In step S520, a start address is read from the user comment field of the image file, and the region image is composed to the image according to the start address, thereby obtaining an image without data information. In step S522, the image is displayed in the display unit 140. In step S524, it is determined whether the image without data information is to be saved. If not (No in step S524), the procedure is complete. If so (Yes in step S524), in step S526, the composed image is compressed, and in step S528, the compressed image is stored to the storage unit 130.

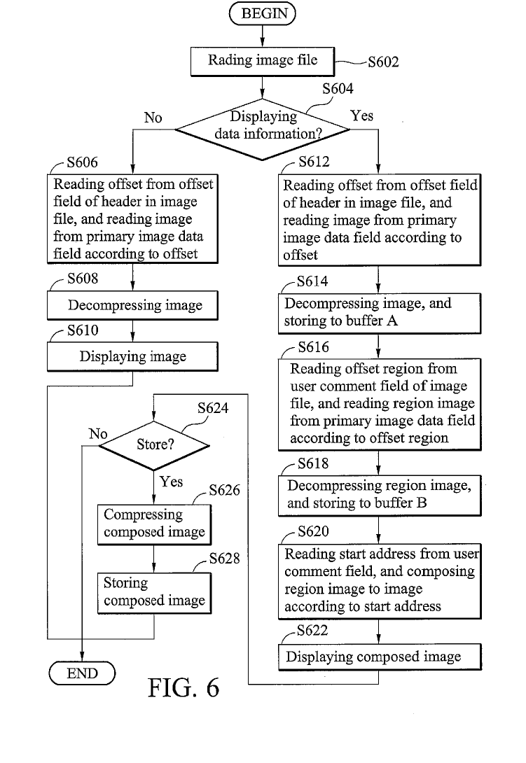

FIG. 6 shows an embodiment of an image processing method. In this embodiment, it is determined whether data information is to be displayed on the image. The image file generated according to FIG. 4 can be used in this embodiment.

In step S602, an image file is read from the storage unit 130. In step S604, it is determined whether to display data information. Similarly, a specific field, such as user comment field of the image file generated according to the invention can be used to record a specific tag such as 1, representing a region image existed in the image file. When the specific tag is read and if the tag is 1, step S604 is performed. If not (No in step S604), in step S606, an offset is read from the offset field of the header of the image file, and an image is read from the primary image data field of the image file according to the offset. In step S608, the image is decompressed to obtain the image without data information, and in step S610, the image is displayed in the display unit 140. If so (Yes instep S604), in step S612, an offset is read from the offset field of the header of the image file, and an image is read from the primary image data field according to the offset. In step S614, the image is decompressed to obtain an image without data information, and stored to buffer A. In step S616, an offset region is read from the user comment field of the image file, and a region image is read from the primary image data according to the offset region. In step S618, the region image is decompressed, and stored to buffer B. It is noted that the region image comprises the data information. In step S620, a start address is read from the user comment field of the image file, and the region image is composed to the image according to the start address, thereby obtaining an image with data information. In step S622, the image is displayed in the display unit 140. In step S624, it is determined whether the image with data information is to be saved. If not (No in step S624), the procedure is complete. If so (Yes in step S624), in step S626, the composed image is compressed, and in step S628, the compressed image is stored to the storage unit 130. It is understood that the embodiments of FIG. 5 and FIG. 6 can be performed in digital cameras or devices separate from the cameras, such as computer systems.

Image processing methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image processing method for use in a camera, comprising:
capturing an image;
copying a region image of a specific region in the image;
stamping data information on the specific region of the image;
recording the region image, a start address of the specific region in the image, and an offset region corresponding to the region image to an image file; and
recording the image with the data information and an offset corresponding to the image to the image file.

2. The method of claim 1 further comprising:
recording the region image to a first field of the image file; and
recording the start address and the offset region to a second field of the image file,
wherein the offset region is a range in the first field occupied by the region image.

3. The method of claim 2 further comprising:
recording the image following the region image in the first field of the image file; and
recording the offset to a third field of the image file,
wherein the offset is a storage address of the image in the first field.

4. The method of claim 3 wherein the first field comprises a primary image data field of the image file, the second field comprises a user comment field of the image file, and the third field comprises an offset field of a header of the image file.

5. The method of claim 1 further comprising:
obtaining the image file; and
reading the offset from the image file, and reading the image according to the offset, thereby obtaining the image with the data information.

6. The method of claim 5 further comprising:
compressing the image and the region image before the image and the region image are recorded to the image file; and
decompressing the image after the image is read from the image file.

7. The method of claim 1 further comprising:
obtaining the image file;
reading the offset from the image file, and reading the image according to the offset;
reading the offset region from the image file, and reading the region image according to the offset region; and
reading the start address from the image file, and composing the region image to the image according to the start address, thereby obtaining the image without the data information.

8. The method of claim 7 further comprising:
compressing the image and the region image before the image and the region image are recorded to the image file; and
decompressing the image and the region image after the image and the region image are read from the image file.

9. The method of claim 1 wherein data information comprises date, time, location, or temperature information.

10. An image processing method, comprising:
obtaining an image file;
reading an offset from the image file, and reading an image according to the offset;
reading an offset region from the image file, and reading a region image according to the offset region; and
reading a start address from the image file, and composing the region image to the image according to the start address.

11. An image processing method for use in a camera, comprising:
capturing an image;
copying a region image of a specific region in the image;
stamping data information on the region image;
recording the region image, a start address of the specific region in the image, and an offset region corresponding to the region image to an image file; and
recording the image and an offset corresponding to the image to the image file.

12. The method of claim 11 further comprising:
obtaining the image file;
reading the offset from the image file, and reading the image according to the offset;
reading the offset region from the image file, and reading the region image according to the offset region; and
reading the start address from the image file, and composing the region image to the image according to the start address, thereby obtaining the image with the data information.

13. An image processing system, comprising:
an image sensor capturing an image; and
a processing unit copying a region image of a specific region in the image, stamping data information on the specific region of the image, recording the region image, a start address of the specific region in the image, and an offset region corresponding to the region image to an image file, and recording the image with the data information and an offset corresponding to the image to the image file.

14. The system of claim 13 wherein data information comprises date, time, location, or temperature information.

15. The system of claim 13 wherein the region image is recorded in a first field of the image file, the start address and the offset region are recorded in a second field of the image file, the offset region is a range in the first field occupied by the region image, the image is recorded following the region image in the first field of the image file, the offset is recorded in a third field of the image file, and the offset is a storage address of the image in the first field.

16. The system of claim 13 wherein the processing unit obtains the image file, reads the offset from the image file, and reads the image according to the offset, thereby obtaining the image with the data information.

17. The system of claim 13 wherein the processing unit obtains the image file, reads the offset from the image file, reads the image according to the offset, reads the offset region from the image file, reads the region image according to the offset region, reads the start address from the image file, and composes the region image to the image according to the start address, thereby obtaining the image without the data information.

18. The system of claim 17 wherein the processing unit compresses the image and the region image before the image and the region image are recorded to the image file, and decompresses the image and the region image after the image and the region image are read from the image file.

19. An image processing system, comprising:
an image sensor capturing an image; and
a processing unit capturing an image, copying a region image of a specific region in the image, stamping data information on the region image, recording the region image, a start address of the specific region in the image, and an offset region corresponding to the region image to an image file, and recording the image and an offset corresponding to the image to the image file.

20. The system of claim 19 wherein the processing unit obtains the image file, reads the offset from the image file, reads the image according to the offset, reads the offset region from the image file, reads the region image according to the offset region, reads the start address from the image file, and composes the region image to the image according to the start address, thereby obtaining the image with the data information.
